(19) United States
(12) Patent Application Publication
(10) Pub. No.: US 2018/0178731 A1
(43) Pub. Date: Jun. 28, 2018

(54) LUGGAGE COMPARTMENT COVER FOR A MOTOR VEHICLE

(71) Applicant: BOS GMBH & CO. KG, Ostfildern (DE)

(72) Inventor: Markus HINTENNACH, Baltmannsweiler (DE)

(21) Appl. No.: 15/735,754

(22) PCT Filed: May 30, 2016
(86) PCT No.: PCT/EP2016/062137

§ 371 Date: Dec. 12, 2017

(30) Foreign Application Priority Data
Jun. 17, 2015 (DE) 10 2015 007 650.7

(51) Int. Cl. B60R 5/04

(52) U.S. Cl. CPC B60R 5/047

(57) ABSTRACT

A luggage compartment cover including a flexible cover sheet held on a winding shaft so that it can be wound and unwound between an extended functional position and a wound-up resting position, and substantially dimensionally stable contour section attached to a front end region of the cover sheet in the direction of extension and assigned to a holding element for securing the contour section in the extended functional position at holding areas fixed to the luggage compartment. The contour section is configured such that, starting from a planar orientation, it can be bent toward one side relative to an axis of curvature oriented parallel or coaxially to an axis of rotation of the winding shaft, and is supported toward the opposite side in the planar orientation in an inherently stable manner.

The invention relates to a luggage compartment cover for a motor vehicle, comprising a flexible cover sheet, which is held on a winding shaft so as to be able to be wound up and unwound between an extended functional position and a wound-up inoperative position, and comprising an at least substantially dimensionally stable contour portion, which is attached to a front end region of the cover sheet in the direction of extension, and to which holding elements are assigned for securing the contour portion in the extended functional position of the cover sheet on holding regions fixed to the luggage compartment.

A luggage compartment cover of this type is generally known for a station wagon. The luggage compartment cover is provided in a luggage compartment of the passenger vehicle and has a flexible cover sheet which is held so as to be able to wound up and unwound on a winding shaft. The winding shaft is accommodated in a cassette housing which is mounted fixed to the vehicle behind a backrest arrangement of a rear seat bench approximately level with a vehicle ledge. The cover sheet can be pulled rearward out of the cassette housing toward a tailgate of the luggage compartment and can be hooked into vehicle-side holding elements in a functional position extended approximately horizontally. For this purpose, the cover sheet has, on its front end region in the direction of extension, a contour portion on which hooking-in pins are provided which are hooked in the vehicle-side holding receptacles in the functional position of the cover sheet. The contour portion is of dimensionally stable design and, in the extended functional position of the cover sheet, covers an intermediate space between an inner trim panel of the tailgate and an end edge of the flexible cover sheet. In the wound-up inoperative position of the cover sheet, the contour portion lies against the cassette housing and protrudes obliquely downward and rearwards out of the cassette housing.

It is the object of the invention to provide a luggage compartment cover of the type mentioned at the beginning which permits an improved loading capacity for the luggage compartment of the motor vehicle.

This object is achieved in that the contour portion is configured in such a manner that, starting from a flat orientation, it is supported so as to be able to be curved toward one side relative to an axis of curvature oriented parallel or coaxially with respect to an axis of rotation of the winding shaft and so as to be dimensionally rigid toward the opposite side in the flat orientation. By means of the solution according to the invention, it is possible to at least partially wind up the contour portion onto the winding shaft together with the flexible cover sheet and accordingly to accommodate the contour portion in a space-saving manner in the wound-up inoperative position of the cover sheet. This increases a loading capacity of the luggage compartment of the motor vehicle. In addition, in the wound-up inoperative position of the cover sheet, the loading compartment cover is realized more compactly than in the prior art, and therefore, upon removal from the luggage compartment, it requires a reduced stowage space in comparison to the prior art for corresponding storage. Accordingly, in the extended functional position of the cover sheet, the contour portion maintains its dimensionally stable function by being supported in a dimensionally rigid manner in a flat orientation. The contour portion can be formed integrally or in a number of parts. Particularly advantageously, the luggage compartment cover according to the invention is suitable for passenger vehicles in the form of station wagons, minivans, SUVs or similar vehicles, i.e. for passenger vehicles, the luggage compartment of which is part of the vehicle interior and accordingly merges in open form into a passenger compartment.

In a refinement of the invention, the contour portion has a plurality of slats which extend transversely with respect to the direction of extension and are arranged one behind another in the direction of extension and are connected to one another via hinge regions. The slats are each of dimensionally stable design as seen by themselves and permit the required curvature of the contour portion by means of the corresponding hinge regions between the respectively adjacent slats.

In a further refinement of the invention, the slats have supporting regions which face one another in pairs and are supported against one another in the flat orientation of the contour portion. These supporting regions ensure that the contour portion behaves in a dimensionally rigid manner in the flat orientation, and therefore the desired cover function for the contour portion in the extended functional position of the cover sheet is ensured. The supporting regions are preferably spaced apart from the hinge regions, wherein the hinge regions are assigned to the one side and the supporting regions to the other side of the contour portion.

In a further refinement of the invention, the slats are configured as solid bodies or as open or closed hollow profiles. The slats can be of rail- or strip-shaped design when they are realized as solid bodies. As open hollow profiles, they preferably have U-shaped cross-sectional profiles. As closed hollow profiles, they preferably have a tubular shape with rectangular or round hollow cross sections.

In a further refinement of the invention, the slats are constructed as a single layer or as multiple layers or as a single component or multiple components. The slats can be composed of plastic, of cardboard, of particle board or of a composite material. The slats can be provided with a cover or a coating.

In a further refinement of the invention, the hinge regions are formed by solid body joints which in particular are integrally formed on the slats. The solid body joints are advantageously realized as film hinges. In the case of a single-part configuration of the contour portion, the solid body joints can be formed as plastics bodies in the form of film hinges between the individual slats. Alternatively, the solid body joints can be formed by a flexible material sheet which is connected in a planar manner on one side to the slats and, because of its flexibility, inevitably defines a corresponding solid body joint in the manner of a film hinge between the adjacent slats. Such a flexible material sheet is preferably connected in a planar manner to correspondingly assigned side surfaces of the slats, in particular by means of an integrally bonded, frictional or form-fitting connection. Instead of an individual flexible material sheet, the solid body joints can also be formed by at least two flexible bands which run parallel to one another in the direction of extension and are connected to the slats on one side. Said flexible bands are preferably connected in a planar manner in the same way as in the case of the flexible material sheet.

In a further refinement of the invention, the hinge regions are formed by hinge joints which have mutually complementary joint parts which are assigned to side regions of the slats that are respectively adjacent in pairs. The mutually complementary joint parts can either be connected directly to each other, in particular latched, or they are connected to each other by means of a plug-in pin, which serves as a hinge pin, in the form of a round bar or the like. The joint parts can be integrally formed on the slats or can be fastened thereto as separately produced components.

In a further refinement of the invention, the supporting regions of the slats are assigned friction-increasing elements, in particular permanent magnet elements, which are effective in a flat orientation of the contour portion. The friction-increasing elements support the dimensional stability of the contour portion in the extended functional position of the cover sheet by the slats being secured in a manner lying flush against one another by means of the friction-increasing elements. The friction-increasing elements are effective in a force-limited manner in order not to obstruct the rolling up of the slats in the region of the winding shaft.

In a further refinement of the invention, the hinge regions are provided eccentrically with respect to a center longitudinal plane of the contour portion. This configuration is advantageous in order to ensure the asymmetrical movability of the contour portion with respect to its opposite sides.

In a further refinement of the invention, the contour portion on an upper or lower side lying opposite the hinge regions is provided with at least one elastically stretchable supporting strip which, in the direction of extension of the cover sheet, extends along the slats and is connected to at least two end-side slats. The supporting strip has a friction-increasing function between the adjacent slats, in the same manner as the friction-increasing elements, and assists the joining together of the slats into the flat and flush orientation in which they lie against one another. The at least one elastically stretchable supporting strip can be provided in addition or as an alternative to permanent magnet elements or other friction-increasing elements.

In a further refinement of the invention, the winding shaft is mounted rotatably in a carrying structure, which can be mounted fixed to the luggage compartment, and an end-side slat of the contour portion in the direction of extension is configured in such a manner that, in the stowed state of the contour portion wound up onto the winding shaft, said slat is supported in the winding-up direction on supporting portions of the carrying structure. This ensures that the contour portion is not completely wound up onto the winding shaft, but rather that the end-side slat is supported on the carrying structure. In this refinement, the winding shaft is provided in an advantageous manner with a winding spring which permanently acts upon the winding shaft in the winding-up direction. Accordingly, without the support of the end-side slat, the contour portion, in the wound-up inoperative position, would continue to rotate about the axis of rotation of the winding shaft until a torsional prestress of the winding spring has been consumed. The support by means of the end-side slat ensures that the prestress of said winding spring is maintained and stabilizes the luggage compartment cover in the wound-up inoperative position in a transport state. The carrying structure can be provided as a closed cassette housing with a passage slot for the cover sheet and the contour portion, wherein the passage slot is configured in such a manner that the end-side slat cannot pass through the passage slot. Alternatively, the carrying structure can be formed merely by means of lateral carrying caps, between which the winding shaft freely extends and on which the winding shaft is mounted. The carrying caps preferably also have a configuration which enables the end-side slat of the contour portion to be supported in the wound-up inoperative position of the flexible cover sheet. The end-side slat is preferably configured in a contoured manner. In all cases, the end-side slat has a different dimensioning relative to the remaining slats. The end-side slat can also be provided with correspondingly outwardly protruding holding elements in order to permit the securing in the extended functional position in corresponding vehicle-side holding regions fixed to the luggage compartment. Said holding elements protruding outward toward opposite sides can form the supporting function on the carrying structure in the wound-up inoperative position of the cover sheet.

A starting slat directly adjoining the end edge of the cover sheet is preferably connected fixedly to the end edge of the cover sheet. For this purpose, a piping connection can be provided between the end edge of the cover sheet and the starting slat. The starting slat can also have latching receptacles into which a closing profile of the end edge of the cover sheet is latched.

In a further refinement of the invention, a guide device which is fixed to the luggage compartment is provided for raising an extension level of the contour portion and of the cover sheet in relation to their inoperative position wound up on the winding shaft. This refinement is advantageous if the cover sheet and the contour portion are wound up onto the winding shaft and unwound from the winding shaft in such a manner that both pulling off from the winding shaft and winding up onto the winding shaft take place in the region of a lower side of the winding shaft. By means of the guide device which is arranged fixed to the, luggage compartment, the contour portion can be deflected upward together with the cover sheet at a distance from the winding shaft in the pull-out direction, and therefore a pull-out plane for the contour portion and the cover sheet is provided in the region of an axis of rotation of the winding shaft or even above an axis of rotation of the winding shaft. Said pull-out plane corresponds to the extension level which has been explained above. The guide device can be formed either by an inlet and outlet ramp in the region of the carrying structure mounted fixed to the luggage compartment, or by guide tracks, such as guide rails or similar for the contour portion, which are arranged laterally on corresponding luggage compartment delimiting surfaces, such as in particular luggage compartment side walls, and in which correspondingly laterally outwardly protruding guide pins of the contour portion are guided.

Further advantages and features of the invention emerge from the claims and from the description below of preferred exemplary embodiments of the invention that are illustrated with reference to the drawings.

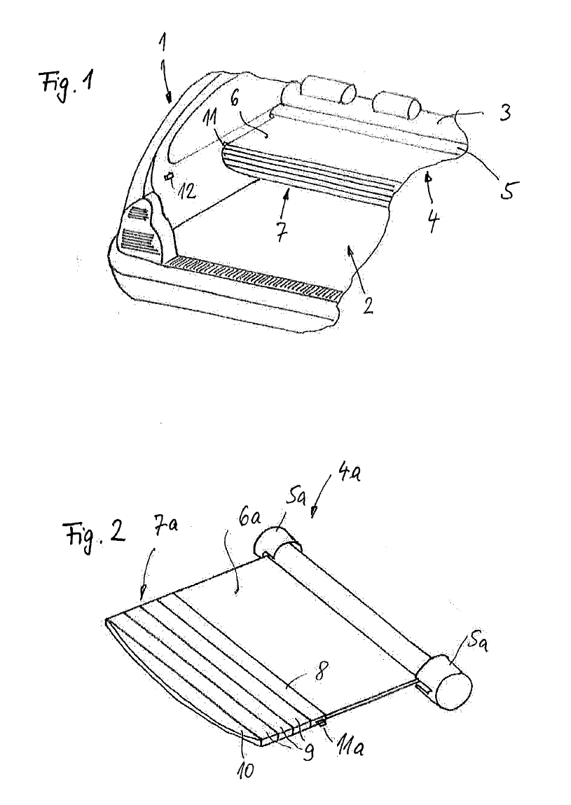

FIG. 1 schematically shows a partial region of a passenger vehicle with an embodiment of a luggage compartment cover according to the invention,

FIG. 2 shows, in a perspective, schematic illustration, a further embodiment of a luggage compartment cover according to the invention similarly to FIG. 1,

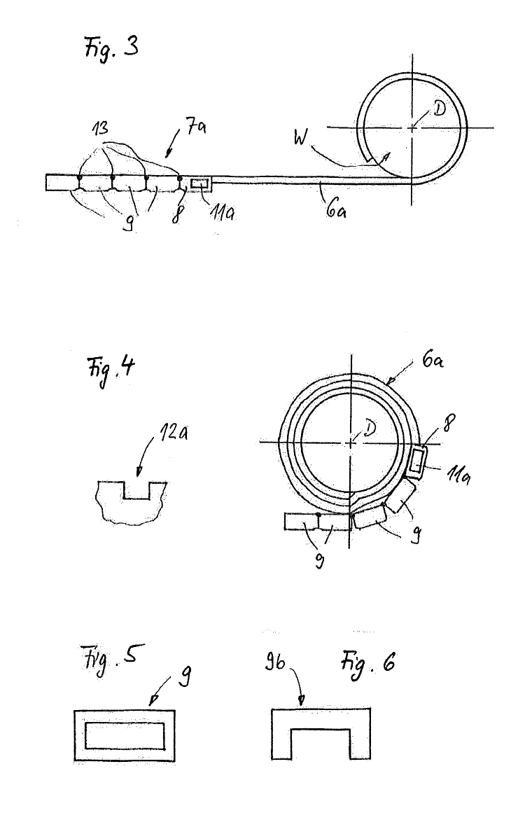

FIG. 3 schematically shows in a side view the luggage compartment cover according to FIG. 2,

FIG. 4 schematically shows in a side view the luggage compartment cover according to FIG. 3 in a wound-up inoperative position,

FIG. 5 schematically shows, in an enlarged illustration, a cross section through a slat of the luggage compartment cover according to FIGS. 2 to 4,

FIG. 6 schematically shows, in a cross-sectional illustration, a further slat of a further embodiment of a luggage compartment cover according to the invention,

FIG. 7 schematically shows a partial region of a further embodiment of a luggage compartment cover according to the invention,

FIG. 8 schematically shows a partial region of a further embodiment of a luggage compartment cover according to the invention,

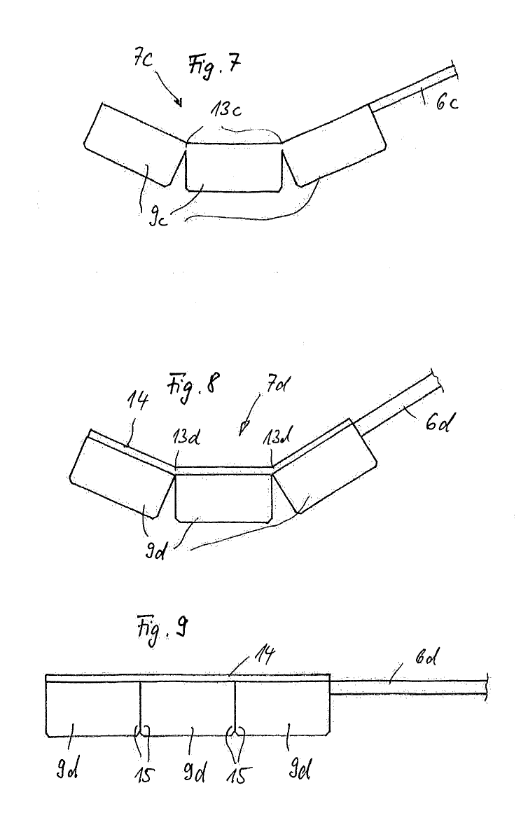

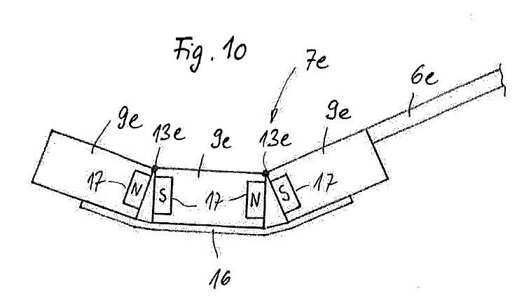

FIG. 9 shows the luggage compartment cover according to FIG. 8 in an extended functional position, and

FIG. 10 schematically shows a partial region of a further embodiment of a luggage compartment cover according to the invention.

A passenger vehicle in the form of a station wagon 1 according to FIG. 1 has a luggage compartment 2 in a rear region. The luggage compartment 2 is delimited toward a vehicle rear by means of a tailgate (not illustrated). Forward toward a passenger compartment, the luggage compartment 2 is delimited by a backrest arrangement 3 of a rear seat bench. Toward its opposite sides, the luggage compartment 2 is bounded by respective luggage compartment side walls. The luggage compartment 2 has a luggage compartment floor (not denoted specifically).

In order to be able to conceal objects deposited in the luggage compartment 2 on the luggage compartment floor against being viewed from the outside, a luggage compartment cover 4 is provided. The luggage compartment cover 4 has a flexible cover sheet 6 in the form of a cover tarpaulin which is held so as to be able to be wound up and unwound on a winding shaft W (FIG. 3). The winding shaft W is mounted rotatably in a carrying structure 5 which, in the embodiment according to FIG. 1, is designed as a dimensionally stable cassette housing. The cassette housing is fastened on the luggage compartment side level with a vehicle side ledge and in the fastened state is positioned directly behind the backrest arrangement 3 of the rear seat bench. The cassette housing extends in the transverse direction of the vehicle. The cover tarpaulin 6 can be pulled out through a passage slot of the cassette housing approximately horizontally rearward toward the vehicle rear region. In order to wind up the cover sheet 6, the winding shaft has a winding spring (not illustrated) which is effective in the winding-up direction and exerts a permanent torque on the winding shaft in the winding-up direction.

The cover sheet 6 is connected at its front end region in the pulling-out direction to a dimensionally stable contour portion 7, to which holding elements 11 are assigned which protrude outward to opposite sides and can be hooked into holding regions, which are fixed to the luggage compartment, on the opposite luggage compartment side walls in order to secure the cover sheet 6 in a manner fixed to the luggage compartment in the extended functional position. In the extended functional position, the contour portion 7 projects rearward in a flat, dimensionally stable orientation to an inner side of the tailgate (not illustrated) in order likewise to cover an intermediate space remaining between the inner side of the tailgate and the end region of the cover sheet 6 against being viewed from the outside.

According to the invention, the contour portion 7 is formed by a plurality of slats which extend in the transverse direction of the vehicle, are dimensionally stable over a width of the contour portion 7, are oriented parallel to an axis of rotation D of the winding shaft W (FIG. 3) and are arranged directly behind one another in the direction of extension of the cover tarpaulin 6. The slats of the contour portion 7 are connected to one another via hinge regions in a manner described in more detail below. The contour portion 7 of the luggage compartment cover 4 according to FIG. 1 is merely illustrated schematically. Various embodiments of the contour portion which are arranged and used in accordance with the illustration according to FIG. 1 are explained in more detail with reference to FIGS. 2 to 10.

It can be seen with reference to FIG. 2 that the luggage compartment cover 4a, which is usable in a luggage compartment of a passenger vehicle in the same manner as the embodiment according to FIG. 1, as carrying structure 5a is not provided with a cassette housing which is continuous over the entire length of the carrying structure, but rather with tubular or cup-shaped lateral carrying caps, between which the winding shaft W extends and on which the winding shaft is rotatably mounted. In the case of the carrying structure 5a according to FIG. 2, the winding shaft is assigned a winding spring in the same manner as has already been described with reference to the embodiment according to FIG. 1. The lateral carrying caps of the carrying structure 5a are provided with slot regions (not denoted specifically) through which the cover sheet 6a can be retracted or extended. The luggage compartment cover 4a is configured to be functionally identical to the luggage compartment cover 4 according to FIG. 1, wherein the same reference numbers have been selected for identical parts or portions, with the addition of the letter a. The cover sheet 6a is provided at its front end region in the pull-out direction with a contour portion 7a which has a total of five slats. The slats are formed by a starting-side slat 8 which is fastened to the end region of the cover sheet 6a and which is adjoined rearward in the longitudinal direction of the vehicle, i.e. to the front in the pull-out direction, by three further slats 9. On the end side, the contour portion 7a is bounded by an end-side slat 10. The starting-side slat 8 and the slats 9 are configured identically to one another. According to FIGS. 3 and 4, all of the slats 8 to 10 are connected to one another via hinge regions 13 which, in the case of the embodiment according to FIGS. 2 to 4, are formed as solid body joints in the form of film hinges. The slats 8, 9 and 10 are composed of plastic, wherein the slats 8, 9 are configured as square hollow profiles according to FIG. 5. The starting-side slat 8 is assigned the lateral holding elements 11a which, according to FIG. 4, are releasably fixable in vehicle-side holding regions 12a on opposite luggage compartment side walls.

It can be seen with reference to FIGS. 3 and 4 that the hinge regions 13 are provided in the region of an upper side of the contour portion 7a between two adjacent slats 8, 9 in each case. All of the hinge regions define hinge axes which are oriented parallel to the axis of rotation D of the winding shaft W. The contour portion 7a is configured integrally by all of the slats 8 to 10 being integrally connected to one another via hinge regions 13, which are configured as film hinges.

It can be seen with reference to FIG. 2 that the end-side slat 10 has a different outer contour than the remaining slats 8, 9. The end-side slat 10 on the one hand follows an inner contour of the inner side of the tailgate. On the other hand, the end-side slat 10 is configured differently to the remaining slats 8, 9 in order to be able to be supported on the slot regions of the carrying structure 5a during the winding up of the cover sheet 6a and of the slats 8, 9. This is because, as a result of the fact that the hinge regions 13 are positioned in the region of an upper side of the contour portion 7a and the cover sheet 6a is wound up from below together with the contour portion 7a onto the winding shaft B, the contour portion 7a according to FIG. 4 can curve about the winding shaft W such that the contour portion 7a can be partially wound up at the same time onto the winding shaft W. The end-side slat 10, which is supported on the slot regions of the carrying structure 5a, prevents the contour portion 7a from being fully wound up onto the winding shaft W, as a result of which the winding shaft W can be further rotated in the winding-up direction by the restoring force of the winding spring, because of a lack of counterforces, until the winding spring has lost its pretensioning. By means of the support of the end-side slat 10, the winding spring remains in a desired pretensioning position and the contour portion 7a remains in a state wound up in a defined manner.

As already described, the slats 8, 9 are provided with square cross-sectional profiles (FIG. 5), but more precisely with rectangular cross-sectional contours. This gives rise below the hinge regions 13 to supporting regions of the side walls, which each lie against each other in pairs, of adjacent slats 8, 9, and therefore, in the extended functional position, in which the holding elements 11a are hooked in the holding regions 12a, the contour portion 7a protrudes freely rearward in a flat orientation toward the rear region.

It can be seen with reference to FIG. 6 that the slats 9b can also be provided with a U-shaped cross-sectional profile and can nevertheless be used in the same manner as in the case of the contour portion 7a according to FIGS. 2 to 4. Corresponding U limbs of the slats 9b are directed downward, and therefore the slats 9b retain a flat, planar configuration in the region of their upper sides, which also include the hinge regions 13.

In the embodiment according to FIGS. 2 to 4, the hinge regions 13 can also be formed by hinge joints, wherein corresponding joint parts are in each case provided on the side regions of the slats 8, 9, 10 which are adjacent in pairs. The joint parts which are assigned to one another in pairs are formed in a complementary manner with respect to one another and can be connected to one another via a hinge pin, preferably in the form of a round bar, forming the desired hinge joint. In such a configuration, the slats 8 to 10 are first of all produced separately from one another and are subsequently connected to one another via the hinge pins.

Various modifications of contour portions 7a to 7e are illustrated with reference to FIGS. 7 to 10, which modifications can be used in a luggage compartment cover 4 or 4a in the same manner as has already been described with reference to FIGS. 1 to 6. Accordingly, in order to avoid repetitions, reference is made to the disclosure regarding the luggage compartment covers 4 and 4a according to FIGS. 1 to 6. The respective cover sheet 6c to 6e is designed identically to the cover sheet 6 or 6a according to FIGS. 1 and 2 and is additionally provided with a letter c, d or e for simple assignment to the respective embodiment.

In all of the embodiments, a corresponding end region of the cover tarpaulin 6 to 6e is connected to the respective starting-side slat 8, 9a to 9e releasably or nonreleasably, in a form-fitting, frictional or integrally bonded manner or as a combination of the various types of connection.

In the embodiment according to FIG. 7, the contour portion 7c is designed as a single-part plastics component, wherein the individual slats 9c are connected to one another in the region of their upper side via solid body joints 13c. The solid body joints 13c which constitute corresponding hinge regions are formed by web connections in the form of film hinges.

In the embodiment according to FIG. 8, the contour portion 7d has slats 9d which are produced separately from one another and are connected to one another in the region of their upper side via a flexible material sheet 14. The material sheet 14 extends over an entire width and length of all of the slats 9d and accordingly of the entire contour portion 7d, and therefore the material sheet 14 forms an upper-side coating of the contour portion 7d. The material sheet 14 is formed by a single- or multi-layered sheet structure composed of a plastics film or a textile web. The slats 9d can be produced from plastic, from wood, from cardboard, from particle board or from similar, sufficiently dimensionally rigid materials. In the exemplary embodiment according to FIGS. 8 and 9, the material sheet 14 is connected in a planar manner to the upper sides of the slats 9d. A correspondingly planar connection can take place by means of double-sided adhesive tape, by means of an adhesive layer of a liquid adhesive or by means of welding or else by means of other types of connection. It can also be seen with reference to FIGS. 8 and 9 that, analogously to the previously described embodiments, the slats 9d have substantially rectangular outer contours—based on a cross-sectional profile of the slats 9b—which define side walls lying in a planar manner against one another. These side walls of the respectively adjacent slats 9d form supporting regions 15 at a distance below the hinge regions 13d, which are formed by the material sheet 14, by means of which supporting regions the slats 9d are supported in a flat orientation on one another in an extended functional position of the contour portion 7d and of the cover sheet 6d according to FIG. 9.

In the embodiment according to FIG. 10, a flat orientation of the contour portion 7e in the extended functional position of the cover sheet 6e is also supported by additional friction-increasing elements 17 in the form of permanent magnets which pull the mutually facing side walls of the adjacent slats 9e toward one another and thus support the flush and flat orientation of the slats 9e with respect to one another.

In addition or alternatively to corresponding permanent magnets, the contour portion 7e has, on its lower side opposite the hinge regions 13e, at least one elastically stretchable supporting strip 16 which is preferably produced from an elastomer material. As soon as the contour portion 7e is transferred from its flat orientation into its curved orientation according to FIG. 10, the at least one elastic supporting strip 16, which is connected to all of the slats 9e, is stretched elastically in the transition region between the respectively adjacent slats 9e, as a result of which tensile forces inevitably arise which act on the slats 9e. Said tensile forces attempt to pull the slats 9e against one another again in the region of their lower side opposite the hinge regions 13e, as a result of which the at least one supporting strip 16 assists the pulling together of the slats 9e to form the flat and flush orientation. The at least one supporting strip 16 can also be fastened only to the end-side slats and can lie against the slats located in-between only under prestress, without being fixedly connected thereto.

Instead of an individual material sheet 14 according to FIGS. 8 and 9, a plurality of flexible bands which extend in the longitudinal direction of the cover sheet 6d and accordingly in the pull-out direction and which are oriented parallel to one another and are arranged distributed over the width of the contour portion 7d can also be provided. Said flexible bands can be connected to the upper sides of the slats 9d in the same manner as has been described in more detail for the material sheet 14 according to FIGS. 8 and 9.

In all of the embodiments according to FIGS. 1 to 10, the respective contour portion 7 to 7e is at least substantially wound up onto the winding shaft W, as a result of which an axis of curvature which is oriented parallel or coaxially with respect to the axis of rotation D of the winding shaft W arises for the respective contour portion 7 to 7e. In the extended functional position of the cover sheet 6 to 6e and of the contour portions 7 to 7e, the contour portion 7 to 7e is in each case held releasably in the region of its starting-side slat 8, 9 to 9e, i.e. in the region of the slat which directly adjoins the end region of the cover sheet 6 to 6e, in the luggage-compartment-side holding regions 12, 12a. As a result, the slats adjoining the starting-side slat toward the rear region protrude freely rearward. By means of the dead weight of the slats 9 to 9e and by means of the arrangement of the hinge regions, eccentrically with respect to a center longitudinal plane of the respective contour portion 7 to 7e in the region of an upper side, the slats attempt to each tilt downward and are supported against one another by the supporting regions in the region of the lower side and by the mutually parallel, mutually facing side walls of respectively adjacent slats. This results in the desired flat and dimensionally stable orientation of the respective contour portion 7 to 7e in the extended functional position of the respective cover sheet 6 to 6e.

1. A luggage compartment cover for a motor vehicle, comprising a flexible cover sheet, which is held on a winding shaft so as to be able to be wound up and unwound between an extended functional position and a wound-up inoperative position, and comprising an at least substantially dimensionally stable contour portion, which is attached to a front end region of the cover sheet in the direction of extension, and to which holding elements are assigned for securing the contour portion in the extended functional position of the cover sheet on holding regions fixed to the luggage compartment, wherein the contour portion is configured in such a manner that, starting from a flat orientation, it is supported so as to be able to be curved toward one side relative to an axis of curvature oriented parallel or coaxially with respect to an axis of rotation of the winding shaft and so as to be dimensionally rigid toward the opposite side in the flat orientation.

2. The luggage compartment cover as claimed in claim 1, wherein the contour portion has a plurality of slats which extend transversely with respect to the direction of extension and are arranged one behind another in the direction of extension and are connected to one another via hinge regions.

3. The luggage compartment cover as claimed in claim 2, wherein the slats have supporting regions which face one another in pairs and are supported against one another in the flat orientation of the contour portion.

4. The luggage compartment cover as claimed in claim 1, wherein the slats are configured as solid bodies or as open or closed hollow profiles.

5. The luggage compartment cover as claimed in claim 1, wherein the slats are constructed as a single layer or as multiple layers or as a single component or multiple components.

6. The luggage compartment cover as claimed in claim 2, wherein the hinge regions are formed by solid body joints which in particular are integrally formed on the slats.

7. The luggage compartment cover as claimed in claim 2, wherein the hinge regions are formed by hinge joints which have mutually complementary joint parts which are assigned to side regions of the slats that are respectively adjacent in pairs.

8. The luggage compartment cover as claimed in claim 6, wherein the solid body joints are formed by at least two flexible bands which run parallel to one another in the direction of extension and are connected to the slats on one side.

9. The luggage compartment cover as claimed in claim 1,
wherein the supporting regions of the slats are assigned friction-increasing elements, in particular permanent magnet elements, which are effective in a flat orientation of the contour portion.

10. The luggage compartment cover as claimed in claim 1,
wherein the hinge regions are provided eccentrically with respect to a center longitudinal plane of the contour portion.

11. The luggage compartment cover as claimed in claim 1, wherein the contour portion on an upper or lower side lying opposite the hinge regions is provided with at least one elastically stretchable supporting strip which, in the direction of extension of the cover sheet, extends along the slats and is connected to at least two end-side slats.

12. The luggage compartment cover as claimed in claim 1,
wherein the winding shaft is mounted rotatably in a carrying structure, which can be mounted fixed to the luggage compartment, and in that an end-side slat of the contour portion in the direction of extension is configured in such a manner that, in the stowed state of the contour portion wound up onto the winding shaft, said slat is supported in the winding-up direction on supporting portions of the carrying structure.

13. The luggage compartment cover as claimed in claim 1,
wherein a guide device which is fixed to the luggage compartment is provided for raising an extension level of the contour portion and of the cover sheet in relation to their inoperative position wound up on the winding shaft.
